(19) United States
(12) Patent Application Publication
(10) Pub. No.: US 2018/0094965 A1
(43) Pub. Date: Apr. 5, 2018

(54) METHOD FOR FILL LEVEL DETERMINATION

(71) Applicant: Endress+Hauser Conducta GmbH+Co. KG, Gerlingen (DE)

(72) Inventors: Matthias Altendorf, Lorrach (DE); Manfred Jagiella, Notzingen (DE); Andreas Mayr, Lorrach (DE)

(21) Appl. No.: 15/715,829

(22) Filed: Sep. 26, 2017

(30) Foreign Application Priority Data
Oct. 4, 2016 (DE) 10 2016 118 726.7

(51) Int. Cl. G01F 23/292

(52) U.S. Cl. CPC G01F 23/292; G01J 5/48

(57) ABSTRACT

The present disclosure relates to a system for determining at least one process variable, such as a fill level of a filling material located in a container. The system includes at least one camera for taking at least one image of at least one first subregion of the container, at least one thermal-imaging camera for taking at least one thermal image of at least the first subregion, and an evaluation unit. The evaluation unit determines the process variable based upon the at least one thermal image in combination with the at least one image, wherein the latter is used in the determination of the container geometry. The system according to the present disclosure thus offers the advantage that none of the components must be arranged in the interior of the container.

### CROSS-REFERENCE TO RELATED APPLICATION

The present application is related to and claims the priority benefit of German Patent Application No. 10 2016 118 726.7, filed on Oct. 4, 2016, the entire contents of which are incorporated herein by reference.

### TECHNICAL FIELD

The present disclosure relates to a method for determining a fill level or for determining other process variables by means of a thermal-imaging camera and a photographic camera, and to a system that is suitable for performing the method.

### BACKGROUND

In automation technology, in particular, in process automation technology, field devices serving to detect and/or modify process variables are frequently used. In order to detect process variables, sensors are used, which are, for example, integrated into fill level measuring devices, flow rate measuring devices, pressure and temperature measuring devices, pH redox potential measuring devices, conductivity measuring devices, etc. They detect the respective process variables, such as the fill level, flow rate, pressure, temperature, pH value, redox potential, or conductivity. Actuators, such as valves or pumps among other things, by means of which the flow rate of a liquid in a pipeline section or the fill level in a container can be altered, are used to modify process variables. Within the scope of the present disclosure, the term “container” also refers to containers that are not closed, such as basins, lakes, or flowing bodies of water. All devices that are used near the process and provide or handle process-relevant information are generally called field devices. In connection with the present disclosure, “field devices” therefore also refer to remote I/O's, radio adapters, or, in general, electronic components that are arranged at the field level. A variety of such field devices is manufactured and marketed by the Endress+Hauser company.

For measuring the fill level of filling materials in containers, contactless measuring methods have become established, because they are robust and require minimum maintenance. Another advantage consists in their ability to measure the fill level virtually continuously and at a high resolution. In the field of continuous fill level measurement, predominantly radar-based measuring methods are used. An established measuring principle in this respect is the pulse transit time measuring principle also known by the name, “pulse radar.” In addition, there is also the FMCW method, in which a continuous microwave signal with a changing frequency is used.

Radar-based fill level measuring devices are already sufficiently known from the prior art. By way of example, the publication WO 2015/010814 A1 is mentioned here, from which the functional principle of transit time-based measuring methods for fill level measurement results.

Disadvantageous in radar-based or ultrasound-based methods is that the measuring device must be installed directly in the interior space of the container in which the fill level is to be determined. In addition, it is not possible to determine without additional measuring methods further process variables besides the fill level, such as the filling material temperature or phase boundaries within the filling material or between two different filling materials.

### SUMMARY

The present disclosure is therefore based upon the aim of providing a system for measuring the fill level or additional process variables, which system does not have to be installed on the container.

The present disclosure achieves this aim by means of a system for determining at least one process variable of a filling material located in a container. For this purpose, the system comprises at least one photographic camera for taking at least one optical image of the entire container or of at least one first subregion of the container, at least one thermal-imaging camera for taking at least one thermal image of the same subregion that the photographic camera also records, and an evaluation unit that determines the at least one process variable based upon the at least one optical image and based upon the at least one thermal image.

The system according to the present disclosure thus offers the advantage that none of the components must be arranged in the interior of the container. Accordingly, compared to fill level measuring devices according to the prior art, a simplified assembly of the system is possible.

The fill level (L) or any other process variables are determined according to the present disclosure by means of the image information of the thermal image (I_{H}), wherein the image information of the optical image (I_{P}) of the photographic camera is also factored in. In doing so, actual core information, e.g., the phase boundary between the filling material and the gas atmosphere located above it, is determined by means of the thermal image (I_{H}). By factoring in the image information from the optical image (I_{P}), the phase boundary can be related spatially to the container or its geometry. Overall, knowing the position in the container, the fill-level can thus be determined from the detected phase boundary. Another advantage of the system according to the present disclosure consists in the system not having to be installed permanently and being able to be setup anew at a different location, if need be, since the contour of the container even in case of shifting perspectives is also recorded by means of the camera. Depending upon the size of the container, the system can also be designed as a portable system.

For an optimal implementation of the idea according to the present disclosure, it is advantageous if the first subregion is respectively selected such that at least one section of the outer contour of the container can always be determined. It would be conceivable in this connection for the higher-level unit to autonomously determine whether the currently recorded subregion includes a section of the container contour. If this is not so, a corresponding error message can be output, for example. In this connection, it would also be conceivable for at least one mark to be applied to the container at a known distance from the tank bottom (or from another known reference position), wherein the first subregion in this case is to be selected such that it includes the at least one mark. In this way, a reference mark is provided, by means of which the fill level, for example, can be determined from the image (I_{H}, I_{P}).

If a time-of-flight camera is used as the camera and/or thermal-imaging camera, it is additionally possible to determine the fill level and/or the additional process variable in a spatially-resolved manner, i.e., three-dimensionally.

For a reliable implementation of the system according to the present disclosure, it is furthermore advantageous if the at least one camera and the at least one thermal-imaging camera are arranged outside the container such that the at least one image (I_{P}) and the at least one thermal image (I_{H}) are taken from two different perspectives with a known geometric relation or from about the same perspective.

Depending upon the application of the system according to the present disclosure, e.g., in the case of complex container geometries, it can be advantageous if the system includes several cameras and/or several thermal-imaging cameras for recording different subregions.

In order to increase the contrast of the thermal image (I_{H}) and/or of the image (I_{P}), a light source can be used to illuminate the at least first subregion. If the contrast, specifically, in the thermal image is to be increased, the light source is to be designed preferably such that it emits light at a wavelength to which the at least one thermal-imaging camera has the maximum sensitivity.

Another measure for increasing the contrast can be achieved by the container being designed, at least in the first subregion, such that the wall material of the container has a high transmission coefficient of, in particular, greater than 0.85 at the wavelength at which the sensitivity of the thermal-imaging camera is at a maximum. This can, for example, be achieved by an appropriate selection of the wall material, such as polyethylene or polypropylene.

The aim upon which the present disclosure is based is also achieved by a method for determining at least one process variable of a filling material located in a container. Analogously to the system described above, the method includes the following method steps: an image (I_{P}) of at least one first subregion of the container is taken by at least one camera, a thermal image (I_{P}) of the at least one first subregion of the container is taken by at least one thermal-imaging camera, and the at least one process variable is determined by an evaluation unit based upon the at least one image (I_{P}) and based upon the at least one thermal image (I_{H}).

In doing so, the at least one process variable is preferably the fill level of the filling material in the container and/or at least one filling material temperature and/or one phase boundary within the filling material.

According to the present disclosure, there are no requirements as to which time intervals the images (I_{H}, I_{P}) are to be taken at or how often the determined process variable is updated. In addition to a periodic or an event-driven update, a virtually continuous update is also possible, so that a video is recorded instead. As a result, the temporal curve of the at least one process variable could be determined, in order to, for example, monitor chemical processes that the filling material is undergoing at the moment.

In this respect, it is not relevant whether a new image (I_{P}) is also taken with each update of the thermal image (I_{H}). An update of the image (I_{P}) is required only if the perspective of the camera, and thus the selected (sub)region, changes.

Depending upon the size and the complexity of the container or of the process variable to be determined, it can prove to be advantageous if, in addition to the first subregion, an image (I_{P}) and a thermal image (I_{H}) of at least one second subregion are taken.

A calibration of the system according to the present disclosure could, for example, be performed in which the at least one process variable is known from the outset (for example, by a previous determination otherwise), wherein the subsequent calibration is performed in relation to the known process variable.

### BRIEF DESCRIPTION OF THE DRAWINGS

The present disclosure is explained in more detail with reference to the following FIGURE.

FIG. 1 shows determination of a process variable in a container by means of a thermal-imaging camera in combination with a camera.

### DETAILED DESCRIPTION

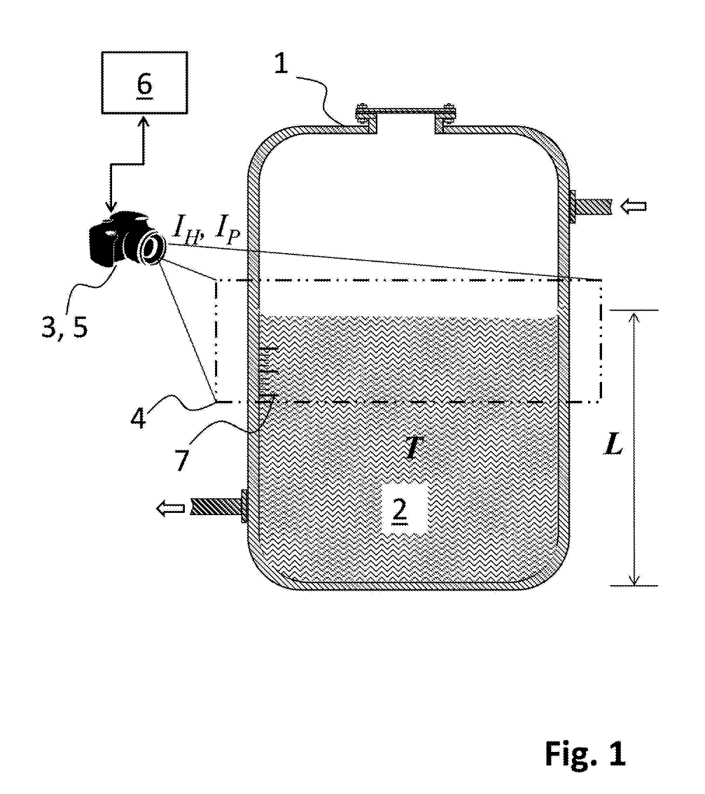

FIG. 1 shows a container 1 with a filling material 2, wherein a process variable of this filling material 2 is to be determined. The process variable is, for example, the temperature T of the filling material, the fill level L, a possible foam layer, or another phase boundary of the filling material 2. In particular, in applications in process automation, it can happen that the filling material 2 in the container 1 undergoes chemical processes. In this case, the process variable can also be a time-resolved and/or spatially-resolved temperature distribution in the container 1. This allows for a monitoring of the ongoing process.

In order to determine the process variable, a photographic camera 3 and a thermal-imaging camera 5 are arranged in the outer region of the container 1. The two cameras 3, 5 are directed such that they take an optical image I_{P} or a thermal image I_{H} of a subregion 4 of the container 1 from about the same perspective. The subregion 4 is in this case selected such that it includes, for one, the portion of the filling material 2 that is relevant to the determination of the process variable by means of the thermal-imaging camera 5.

In addition, the subregion 4 in the exemplary embodiment is selected such that it includes a section of the outer contour of the container 1. This ensures that at least one section of the contour is recorded by the camera 3. It is thereby possible to relate the thermal image I_{H} of the thermal-imaging camera 5 to the contour of the container 1 by means of the evaluation unit 6 and to thus determine, for example, the fill level L in the container 1 as a process variable. In the exemplary embodiment shown, the subregion 4 also includes a mark 7 on the outer wall of the container 1. By means of this mark 7, the scaling of which relates to the distance from the container bottom, it is thus possible to determine the fill level L in relation to the container bottom.

If the process variable is the fill level L, it is also necessary to design the subregion 4 to be large enough so that it can represent both the minimum possible fill level and the maximum possible fill level. If this is not possible as a result of the external conditions on the container 1 or as a result of the limited resolving capacity of the cameras 3, 5, it is also possible as an alternative to the exemplary embodiment shown in FIG. 1 to use several cameras 3 and several thermal-imaging cameras 5, which respectively take images I_{P} or thermal images I_{H} of several different subregions. In this case, the location of the individual subregions in relation to one another should, however, be known.

1. A system for determining at least one process variable of a filling material located in a container, comprising:
at least one photographic camera for taking at least one optical image of at least one first subregion of the container;
at least one thermal-imaging camera for taking at least one thermal image of at least the first subregion; and
an evaluation unit that determines the at least one process variable based upon the at least one optical image and based upon the at least one thermal image.

2. The system of claim 1, wherein the first subregion is selected such that at least one section of an outer contour of the container can be determined.

3. The system of claim 2, wherein the optical image is used to determine the geometry of the container.

4. The system of claim 1, wherein at least one mark is applied to the container at a known distance from a bottom of the container, and wherein the first subregion is selected such that it includes the at least one mark.

5. The system of claim 1, wherein the at least one photographic camera and the at least one thermal-imaging camera are arranged outside the container such that the at least one optical image and the at least one thermal image are taken from two different perspectives with a known geometric relation.

6. The system of claim 1, wherein the at least one camera and the at least one thermal-imaging camera are arranged outside the container such that the at least one optical image and the at least one thermal image are taken from about the same perspective.

7. The system of claim 1, further comprising more than one photographic camera and/or more than one thermal-imaging camera.

8. The system of claim 1, further comprising a light source embodied to illuminate the at least first subregion.

9. The system of claim 7, wherein the light source is structured to emit light at a wavelength to which the at least one thermal-imaging camera has a maximum sensitivity.

10. The system of claim 1, wherein the container is embodied, at least in the first subregion, such that a wall material of the container has a transmission coefficient that is greater than 0.85 at the wavelength at which the sensitivity of the thermal-imaging camera is at a maximum.

11. The system of claim 1, wherein the at least one process variable is a fill level of the filling material in the container and/or at least one filling material temperature and/or one phase boundary within the filling material.

12. The system of claim 1, wherein a temporal curve of the at least one process variable is determined.

13. The system of claim 1, wherein the at least one process variable is known, and wherein a calibration of the system is performed in relation to the known process variable.

14. A method for determining at least one process variable of a filling material located in a container, comprising the steps:
taking at least one optical image of at least one first subregion of the container using at least one photographic camera;
taking at least one thermal image of the at least one first subregion of the container using a thermal-imaging camera; and
determining the at least one process variable using an evaluation unit based upon the at least one optical image and based upon the at least one thermal image.

15. The method of claim 14, the method further comprising taking a second optical image and a second thermal image of at least one second subregion, in addition to the first subregion.

16. The method of claim 14, wherein the at least one process variable is a fill level of the filling material in the container and/or at least one filling material temperature and/or one phase boundary within the filling material.

17. The method of claim 14, the method further comprising determining a temporal curve of the at least one process variable.

18. The method of claim 14, wherein the at least one process variable is known, and the method further comprises performing a calibration of the system in relation to the known process variable.

19. The system of claim 14, the method further comprising determining the geometry of the container using the optical image.
